(19) United States
(12) Patent Application Publication
(10) Pub. No.: US 2026/0361242 A1
(43) Pub. Date: Nov. 12, 2026

(54) SPIN-SEEBECK FERRIMAGNETIC WASTE-HEAT HARVESTER WITH CHI-PATTERNED IMPEDANCE TRANSFORMATION AND ZERO-BIAS RECTIFICATION

(71) Applicant: Jonathan Washburn, Austin, TX (US)

(72) Inventor: Jonathan Washburn, Austin, TX (US)

(21) Appl. No.: 19/675,289

(22) Filed: May 12, 2026

Related U.S. Application Data
(60) Provisional application No. 63/804,599, filed on May 12, 2025.

(51) Int. Cl. H02N 11/00; H01F 10/32

(52) U.S. Cl. CPC H02N 11/002; H01F 10/324

(57) ABSTRACT

A waste-heat energy harvester includes a ferrimagnetic insulator layer configured to generate a spin current in response to a temperature gradient, a heavy-metal layer disposed adjacent to the ferrimagnetic insulator layer and configured to convert the spin current into a charge voltage via an inverse spin Hall effect, and a chi-patterned conductive structure formed from or integrated with the heavy-metal layer. The chi-patterned conductive structure collects the charge voltage, transforms effective source impedance toward a rectifier load, and electrically couples the transduced signal to one or more zero-bias tunnel rectifiers, which rectify the signal to produce DC electrical output. In preferred implementations, the chi-patterned conductive structure includes counter-helical conductive paths and distributed coupling nodes. The harvester may be provided as a thin-film laminate on a flexible substrate for conformal mounting on a curved thermal surface. Optional implementations include output accumulation, regulation, quantized extraction, sensing, telemetry, and machine-verified design predicates.

### CROSS-REFERENCE TO RELATED APPLICATIONS

This application claims priority to U.S. Provisional Patent Application No. 63/804,599, filed May 12, 2025, entitled “Spin-Seebeck Ferrimagnetic Back-Plane Waste-Heat Scavenger Integrated with Recognition-Energy Converters,” the disclosure of which is incorporated herein by reference in its entirety.

### BACKGROUND

The present disclosure relates to solid-state waste-heat energy harvesting. More particularly, the present disclosure relates to thin-film spin-caloritronic devices that convert thermal gradients into electrical output using a ferrimagnetic spin-Seebeck layer, a heavy-metal inverse-spin-Hall transduction layer, and a chi-patterned rectifying interface. In preferred implementations, the disclosed devices are configured as conformal laminates mountable on curved thermal surfaces. Many industrial, transportation, energy, and infrastructure systems expose persistent thermal gradients on surfaces such as pipes, manifolds, ducts, condensers, reactors, and other heat-bearing structures. A substantial portion of this heat is low-grade, spatially distributed, or located on curved or otherwise awkward surfaces that are poorly matched to conventional recovery hardware. As a result, many practical waste-heat environments remain underutilized even when a local temperature differential is continuously present.

Conventional thermoelectric generators can provide direct thermal-to-electrical conversion, but such devices are often associated with rigid material systems, limited conformability, and material-cost or deployment constraints that reduce usefulness on curved industrial surfaces. In many settings, the practical problem is not merely whether thermal energy is present, but whether a compact, solid-state, surface-mountable device can recover that energy without requiring bulky heat exchangers, rigid modules, or complex installation hardware. Spin-caloritronic approaches based on the longitudinal spin-Seebeck effect offer a different conversion pathway in which a temperature gradient across a ferrimagnetic material generates a spin current, and an adjacent heavy-metal layer converts that spin current into an electrical signal through the inverse spin Hall effect. However, prior spin-Seebeck devices have been limited by one or more of relatively weak material response, low power density under modest gradients, mismatch between the transduced source and the electrical load, reliance on external rectification electronics, and the use of rigid substrates that do not lend themselves to conformal deployment. Patterned conductive geometries and rectifying structures have been discussed in other energy-harvesting contexts, but prior approaches have not adequately provided an integrated spin-caloritronic architecture in which a ferrimagnetic spin-Seebeck layer, a heavy-metal inverse-spin-Hall transduction layer, a chi-patterned conductive collection structure, and zero-bias tunnel rectification are combined into a single waste-heat harvesting stack. In particular, prior systems have not adequately addressed the problem of transforming the effective source impedance of the transduction layer toward a rectifier-compatible loading condition within the harvesting structure itself.

Accordingly, a need remains for a compact, conformal, solid-state waste-heat harvester that can be mounted on curved thermal surfaces, convert a thermal gradient into a spin current, convert the spin current into an electrical signal, transform and collect that signal through a chi-patterned conductive architecture, and rectify the signal to directly usable DC electrical output. A further need remains for such a device to be manufacturable as a thin-film laminate, adaptable across multiple ferrimagnetic and heavy-metal material systems, and optionally support structurally guided impedance matching, formal design verification, and output-conditioning architectures without obscuring the core harvesting mechanism.

### SUMMARY

The present disclosure provides a solid-state waste-heat harvester in which a ferrimagnetic insulator is configured to generate a spin current in response to a temperature gradient, a heavy-metal layer is configured to convert the spin current into a charge voltage via the inverse spin Hall effect, and a chi-patterned conductive structure is electrically coupled to zero-bias tunnel diodes so that the transduced signal is impedance-transformed and rectified to DC electrical output. The disclosed subject matter is directed to an integrated spin-caloritronic rectifying harvester built around a thermal-to-spin-to-charge-to-rectified-DC conversion chain. In one aspect, thermal input is applied across a ferrimagnetic spin-Seebeck layer to generate a spin current by the longitudinal spin-Seebeck effect. The spin current is transferred to an adjacent heavy-metal layer, which converts the spin current into a charge voltage by the inverse spin Hall effect. A chi-patterned conductive structure formed from or integrated with the heavy-metal layer collects the resulting charge and transforms effective source impedance toward a rectifier load. One or more zero-bias tunnel diodes receive the collected signal and rectify the signal to produce DC output, which may be delivered directly or optionally conditioned, accumulated, regulated, stored, or supplied to a load.

In preferred implementations, the chi-patterned conductive structure is configured both to transform effective source impedance toward the rectifier load and to suppress first-order perturbative field effects through counter-helical conductive path structure. In preferred implementations, the chi-patterned conductive structure is selected or dimensioned so that a load-to-source impedance ratio r=Z_load/Z_source approaches a J-cost minimum under J(r)=0.5*(r+1/r)−1, with the minimum occurring at r=1. This relation can be used as a disclosed structural design doctrine for selecting or refining chi-pattern geometry, line dimensions, node density, and coupling architecture so as to improve transfer efficiency between the transduction layer and the rectifying layer.

In preferred physical implementations, the ferrimagnetic layer comprises a Co2Y hexaferrite layer and the heavy-metal layer comprises Pt. In further preferred implementations, the Pt layer has a thickness of about 6 nm in a structurally optimized embodiment, and the chi-patterned conductive structure has a period of about 5 um and a linewidth of about 180 nm. In preferred rectifying implementations, the zero-bias tunnel diodes comprise metal-insulator-metal tunnel structures including Ti/Al2O3/Al examples. In preferred packaging implementations, the device is supported by a flexible substrate such as muscovite mica and can be provided as an adhesive-backed conformal laminate with protective encapsulation for mounting on curved thermal surfaces.

In optional implementations, rectified energy is accumulated and released under a quantized extraction protocol. Such implementations can include phi-ratio switched-capacitor accumulation and integer-multiple release of E_coh under an eight-tick or ledger-neutral framework. These output-conditioning and extraction architectures can be used with the disclosed harvester without changing the core waste-heat harvesting mechanism.

In optional or alternative implementations, the ferrimagnetic layer can comprise other ferrimagnetic materials, including Co2Z hexaferrite, BaFe12O19, YIG, or Bi-substituted YIG. The heavy-metal layer can comprise metals other than Pt, including W, Ta, Ir, or Pd. The device can be fabricated on flexible, rigid, or semi-flexible supporting substrates, and can be adapted to alternative stack arrangements, including polymer-supported embodiments, double-sided harvesting embodiments, and mixed-heavy-metal embodiments, while preserving the disclosed thermal-to-spin-to-charge rectifying architecture.

In further aspects, the disclosed harvester can be incorporated into conformal waste-heat recovery laminates, self-powered sensor packages, surface-mounted monitoring systems, and other downstream deployments in which thermal gradients are available on pipes, manifolds, ducts, condensers, process equipment, or other heat-bearing structures. Such downstream embodiments remain subordinate to the disclosed integrated spin-caloritronic harvesting architecture.

In preferred implementations, one or more design relationships, positivity conditions, matching conditions, quantization conditions, performance predicates, or flexibility predicates are machine-verified under a formalized model. By way of example, machine-verified predicates can include spin-current positivity, inverse-spin-Hall voltage positivity, impedance-cost non-negativity, matched-zero-cost conditions, rectified-power non-negativity, extraction quantization, and target performance or flexibility conditions. Such machine verification provides a disclosed design-validation and credibility layer for selected implementations, while the physical make-and-use disclosure remains grounded in the described materials, geometries, fabrication stages, and operating examples.

### BRIEF DESCRIPTION OF FIGURES

FIG. 1 is a schematic cross-sectional view of a waste-heat harvester showing a ferrimagnetic spin-Seebeck layer, a heavy-metal transduction layer, a chi-patterned conductive structure, a rectifying structure, a substrate, and a heat-source interface.

FIG. 2 is a schematic top plan view of a chi-patterned conductive structure showing counter-helical conductive paths, interpenetrating mesh phases, node locations, and representative rectifier-coupling regions.

FIG. 3 is a schematic functional diagram showing thermal-gradient input, spin-current generation, inverse-spin-Hall conversion, impedance transformation, rectification, and DC output.

FIG. 4 is a schematic electrical and matching diagram showing a source impedance, a chi-grid impedance-transform structure, a rectifier load, and a J-cost mismatch relation.

FIG. 5 is a schematic cross-sectional detail view of a zero-bias tunnel rectifier integrated with a chi-patterned conductive region.

FIG. 6 is a schematic side view of a conformal harvester laminate mounted on a curved thermal surface.

FIG. 7 is a process-flow diagram showing representative fabrication stages for the ferrimagnetic layer, heavy-metal layer, chi-patterning, diode integration, encapsulation, and lamination.

FIG. 8 is a block diagram showing optional energy accumulation, optional quantized release, regulation, storage, and load-driving circuitry.

FIG. 9 is a schematic deployment view of a steam-pipe monitoring implementation.

FIG. 10 is a schematic deployment view of a vehicle exhaust or turbo-manifold implementation.

FIG. 11 is a schematic deployment view of a pipeline or HVAC monitoring implementation.

FIG. 12 is a schematic view of alternative device configurations including a polymer-supported implementation, a double-sided implementation, and a mixed-heavy-metal polarity implementation.

### DETAILED DESCRIPTION

The present disclosure provides an integrated spin-caloritronic rectifying harvester configured to convert a thermal gradient into directly usable electrical output through a staged thermal-to-spin-to-charge-to-rectified-DC conversion chain. In the disclosed architecture, a ferrimagnetic insulator generates a spin current under a longitudinal spin-Seebeck thermal gradient, an adjacent heavy-metal layer converts that spin current into a charge voltage through the inverse spin Hall effect, and a chi-patterned conductive structure both collects the transduced signal and transforms effective source impedance for coupling into zero-bias tunnel rectifiers. The disclosed invention is therefore not merely a generic thermal scavenger, generic rectifier package, or generic Recognition Science platform, but an integrated waste-heat harvesting architecture built around the stated conversion chain.

In preferred implementations, the disclosed harvester is configured as a thin-film laminate that can be mounted on a curved thermal surface and operated without bulky external heat-exchange hardware. The architecture is particularly suited for distributed or surface-bound heat sources for which conventional rigid thermoelectric modules are poorly matched. The disclosed arrangement can be used to recover heat from pipes, manifolds, ducts, condensers, process equipment, and other heat-bearing surfaces while preserving a compact layer-by-layer stack that supports direct thermal coupling, electrical collection, rectification, and optional downstream conditioning or storage.

The device may be understood in terms of cooperating functional modules. A ferrimagnetic spin-Seebeck module receives a thermal gradient and produces a spin current. A heavy-metal inverse-spin-Hall transduction module receives the spin current and produces a charge voltage. A chi-patterned collection and impedance module distributes and collects the charge while transforming effective source impedance toward the rectifier load. A zero-bias rectification module converts the collected signal into DC output. Optional substrate, encapsulation, accumulation, regulation, and deployment modules may be added without changing the core harvesting mechanism. Inputs to the disclosed system can include thermal-gradient magnitude, layer geometry, material selection, and electrical load conditions. Outputs can include spin current, charge voltage, rectified DC output, regulated output, stored energy, or power delivered to a local or remote load.

For convenience of description, representative variables that may be used in the disclosed implementations include spin-current density J_s, inverse-spin-Hall voltage V_ISHE, source impedance Z_source, chi-structure impedance Z_chi, load impedance Z_load, load-to-source ratio r=Z_load/Z_source, matching cost J(r)=0.5*(r+1/r)−1, rectification efficiency eta_rect, rectified power P_DC, and power density. These variables are used to describe preferred operating relationships and design-refinement logic and should not be read as limiting unless expressly recited in the claims.

As used herein, “effective source impedance” refers to the Thevenin-equivalent impedance presented by the heavy-metal/chi-patterned conductive structure at the rectifier coupling node(s) under a specified operating condition. In preferred implementations, the chi-patterned conductive structure is selected so that the load-to-source ratio r=Z_load/Z_source is within a predetermined tolerance band around unity, such as within +/−10 percent of 1.0, or such that J(r)=0.5*(r+1/r)−1 is less than a predetermined threshold, such as 0.01, thereby providing an objective matching criterion for impedance transformation and transfer efficiency.

In preferred implementations, one or more aspects of the disclosed harvester are selected, interpreted, or optimized under a Recognition Science cost framework. In that framework, the preferred cost relation is J(x)=0.5*(x+1/x)−1, which is treated as the preferred matching and balance relation for selected device-level design choices. In preferred implementations, phi is treated as a preferred self-similarity constant, E_coh=phi\hat{ }−5 is treated as a preferred coherence quantum for quantized extraction embodiments, and eight-tick phase balance is represented by the relation sum_{k=0}\hat{ }{7} exp(2pii*k/8)=0. These RS-linked relations are not required to practice the broadest physical harvester architecture, but they provide a preferred structural doctrine for chi-grid geometry, impedance matching, and optional extraction control. In preferred formalized implementations, the chi-grid angular offset, the J-cost minimum at r=1, and quantized extraction in integer multiples of E_coh are treated as structurally determined within the modeled framework.

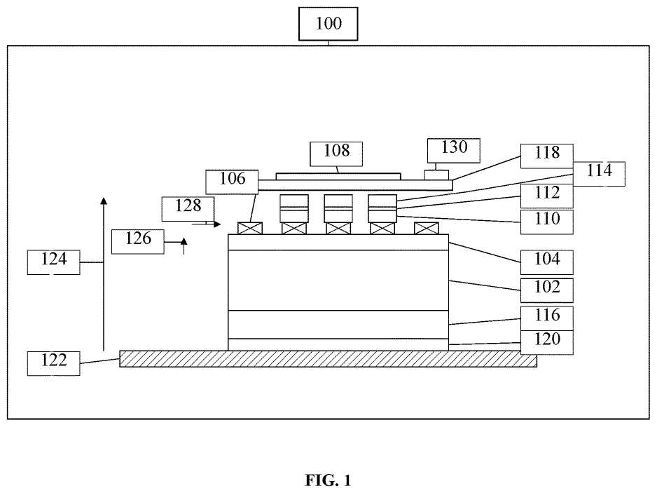

FIG. 1 is a schematic cross-sectional view of a representative waste-heat harvester 100. As shown, the harvester 100 can include a ferrimagnetic insulator layer 102, a heavy-metal inverse-spin-Hall layer 104, a chi-patterned conductive region 106 associated with the heavy-metal layer 104, a tunnel-diode array 108, a lower diode electrode 110, a tunnel barrier 112, an upper diode electrode 114, a substrate 116, an encapsulation layer 118, an adhesive backing 120, a thermal source surface 122, a temperature-gradient direction 124, a spin-current direction 126, a charge-voltage direction 128, and one or more output contact regions 130. The illustrated cross-section is schematic and not necessarily to scale. Layer thicknesses, vertical ordering, lateral spacing, and coupling topologies can be adjusted according to fabrication constraints, output targets, and deployment requirements.

In this disclosure, a “chi-patterned conductive structure” includes at least (i) a plurality of conductive traces arranged as counter-helical paths defining (ii) repeated node locations electrically couplable to rectifiers, and (iii) a plurality of parallel conductive paths between a transduction region and at least one bus or output region, such that the structure is capable of both distributed charge collection and geometry-driven impedance transformation relative to an unpatterned strip.

In the illustrated embodiment, the thermal source surface 122 provides a hot-side boundary or elevated-temperature interface relative to an opposite side of the harvester 100, thereby establishing the temperature-gradient direction 124 across at least the ferrimagnetic insulator layer 102. The ferrimagnetic insulator layer 102 is configured to respond to that thermal gradient by generating a spin current, represented schematically by the spin-current direction 126. The heavy-metal layer 104 is disposed adjacent to the ferrimagnetic insulator layer 102 so as to receive the generated spin current and convert that spin current into a charge voltage, represented schematically by the charge-voltage direction 128, through the inverse spin Hall effect. The chi-patterned conductive region 106 is formed from or integrated with the heavy-metal layer 104 and serves as a charge-collection and impedance-transform structure for coupling the transduced signal into the tunnel-diode array 108.

The ferrimagnetic insulator layer 102 can comprise any ferrimagnetic material suitable for generating a spin current under a longitudinal spin-Seebeck thermal gradient. In a preferred embodiment, the ferrimagnetic insulator layer 102 comprises a Co2Y hexaferrite film. In alternative embodiments, the ferrimagnetic insulator layer 102 can comprise Co2Z hexaferrite, BaFe12O19, YIG, Bi-substituted YIG, or other ferrimagnetic materials providing useful spin-Seebeck response under the intended thermal operating conditions. The ferrimagnetic insulator layer 102 is a core functional layer of the disclosed harvester architecture and, in the preferred core implementation, provides the thermal-to-spin conversion stage of the device.

In a preferred implementation, the ferrimagnetic insulator layer 102 comprises Co2Y hexaferrite, also denoted Ba2Co2Fe12O22, selected for a preferred high spin-Seebeck response relative to conventional YIG-based embodiments. In a representative preferred embodiment at about 300 K, the ferrimagnetic layer may have a spin-Seebeck coefficient S_s of about 52 uV/K, a thermal conductivity kappa of about 3.1 W/(mK), a magnon relaxation time tau_mp of about 2.1 ns, a spin-mixing conductance g_updown of about 2.9*10\hat{ }18m\hat{ }−2 at the Co2Y/Pt interface, a film thickness t_FMI of about 5 um, a saturation magnetization M_s of about 0.35 T, and a Curie temperature T_C of about 720 K. In a preferred operational description, a temperature gradient grad(T_z) applied substantially across the film thickness produces a magnon chemical-potential gradient grad(mu_magnon)=−S_s*grad(T_z), and the interfacial spin-current density may be represented as J_s=g_updown*grad(mu_magnon)/(4pi). In preferred embodiments, the Co2Y layer remains ferrimagnetic to temperatures well above ordinary industrial operating temperatures and therefore provides a useful operating margin for curved-surface waste-heat recovery deployments.

The heavy-metal layer 104 can comprise any material suitable for converting a received spin current into a measurable or harvestable charge voltage through the inverse spin Hall effect. In a preferred embodiment, the heavy-metal layer 104 comprises Pt. In alternative embodiments, the heavy-metal layer 104 can comprise W, Ta, Ir, Pd, or other heavy-metal materials with useful spin-Hall response characteristics. In a further preferred implementation, the heavy-metal layer 104 has a thickness selected to balance spin-current absorption, resistivity, and voltage shunting. A Pt thickness of about 6 nm can be used in a structurally optimized preferred embodiment, although other thicknesses may be employed depending on the heavy-metal material, fabrication method, and output goals.

In a representative preferred embodiment, the heavy-metal layer 104 comprises Pt having a spin Hall angle theta_SH of about 0.11, a resistivity rho_Pt of about 40 uohm*cm for a 6 nm film, and a representative channel length l of about 5 mm. In a further preferred implementation, Pt thickness is selected with reference to spin absorption and voltage preservation. Where the spin diffusion length lambda_sf is about 1.4 nm, a Pt thickness t_Pt of about 6 nm gives tanh(t_Pt/(2*lambda_sf))=tanh(6/2.8)=tanh(2.14), which is approximately 0.97, indicating near-maximal spin-current absorption while avoiding excessive voltage shunting. Under a representative Delta T=90 K condition across a 5 um ferrimagnetic layer, grad(T)=90 K/5*10\hat{ }−6 m=1.8*10\hat{ }7 K/m, J_s=S_s*grad(T)=(52*10\hat{ }−6)*(1.8*10\hat{ }7)=936 A/m\hat{ }2, and V_ISHE=theta_SH*rho_Pt*l*J_s gives a calculated value of approximately 96 mV. In the source-reported preferred embodiment, the measured value is about 94 mV, which is within about 2 percent of the calculation. For a representative geometry with width w=5 mm and thickness t_Pt=6 nm, the unpatterned internal resistance may be estimated as R_int=rho_Pt*l/(w*t_Pt), yielding about 66.7 ohms before chi-grid transformation.

The chi-patterned conductive region 106 is not merely decorative patterning. Rather, the chi-patterned conductive region 106 is a core functional collection and impedance-transform element of the disclosed harvester. The chi-patterned conductive region 106 collects and redistributes the transduced charge signal from the heavy-metal layer 104, provides distributed conductive paths and node locations for coupling to the tunnel-diode array 108, and transforms effective source impedance toward the electrical loading presented by the rectification stage. In preferred implementations, the chi-patterned conductive region 106 is configured both to transform effective source impedance toward the rectifier load and to suppress first-order perturbative field effects through counter-helical conductive path structure.

The tunnel-diode array 108 can include one or more zero-bias tunnel diodes electrically coupled to the chi-patterned conductive region 106. In a preferred embodiment, the tunnel-diode array 108 includes metal-insulator-metal tunnel structures in which the lower diode electrode 110 and upper diode electrode 114 are separated by the tunnel barrier 112. In a further preferred embodiment, the lower diode electrode 110 can comprise Ti, the tunnel barrier 112 can comprise Al2O3, and the upper diode electrode 114 can comprise Al. Other zero-bias MIM tunnel-diode stacks may also be used. The tunnel-diode array 108 is configured to rectify the collected signal without requiring external bias circuitry, thereby producing DC output at the output contact region 130 or other downstream output node.

The substrate 116 provides structural support for the thin-film stack and can be selected according to thermal, electrical, and mechanical requirements. In a preferred conformal implementation, the substrate 116 comprises muscovite mica. In alternative embodiments, the substrate 116 can comprise other flexible, semi-flexible, or rigid insulating supports, including polymeric films, ceramic-backed supports, composite laminates, or other compatible substrates. The encapsulation layer 118 can provide environmental protection, electrical isolation, and mechanical stabilization. The adhesive backing 120 can be used in implementations in which the harvester 100 is supplied as a mountable laminate for installation on the thermal source surface 122 or another host surface.

In a representative preferred embodiment, the substrate 116 comprises cleaved muscovite mica having a thickness of about 40 um, a minimum bend radius of about 1.5 mm, a maximum substrate temperature tolerance of about 900 C, and a thermal expansion coefficient of about 9*10\hat{ }−6/K, which closely matches a representative Co2Y thermal expansion coefficient of about 8*10\hat{ }−6/K. The adhesive backing 120 may comprise a silicone pressure-sensitive adhesive rated for continuous operation at about 180 C and having a representative peel strength of about 1.2 MPa. In one preferred packaging implementation, the encapsulation layer 118 comprises a conformal parylene-C coating of about 4 um thickness, and contact openings may be formed, for example, by laser ablation to permit interconnection without materially compromising environmental sealing. In a representative deployment, the mounted laminate can follow surface contours to within about +/−0.1 mm over a span of about 30 cm.

Operation of the device shown in FIG. 1 can be understood as follows. A thermal gradient is established across the ferrimagnetic insulator layer 102 by the thermal source surface 122. The ferrimagnetic insulator layer 102 generates a spin current under that gradient. The heavy-metal layer 104 receives the spin current and converts the spin current into a charge voltage through the inverse spin Hall effect. The chi-patterned conductive region 106 collects the resulting charge, redistributes the signal across node locations coupled to the tunnel-diode array 108, and transforms effective source impedance toward the diode loading condition. The tunnel-diode array 108 rectifies the collected signal to produce DC output for direct use or for optional downstream accumulation, regulation, storage, or load driving.

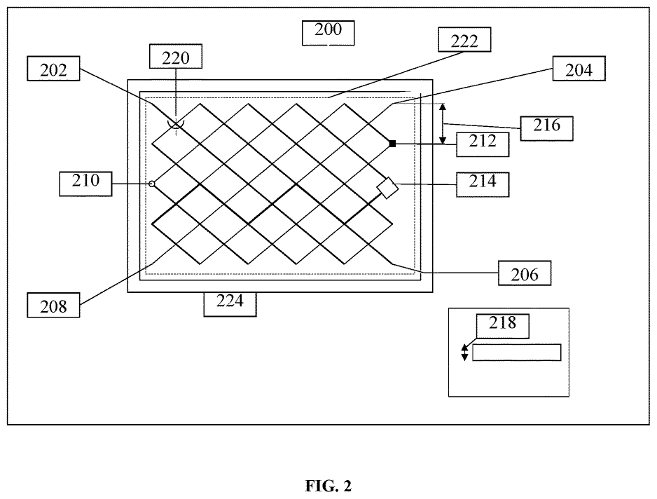

FIG. 2 is a schematic top plan view of a representative chi-grid assembly 200. The chi-grid assembly 200 can include a first counter-helical trace set 202, a second counter-helical trace set 204, a first mesh phase 206, a second mesh phase 208, node locations 210, diode-coupling nodes 212, one or more representative current paths 214, a pitch dimension marker 216, a linewidth dimension marker 218, an angular-offset marker 220, an isolation trench or overetch region 222, and one or more peripheral conductor or bus regions 224. The illustrated geometry is representative and may be repeated over a larger active area. The size, shape, spacing, and angular relationships of the features shown in FIG. 2 can vary according to material choice, fabrication limits, desired impedance, and rectifier-coupling strategy.

The first counter-helical trace set 202 and the second counter-helical trace set 204 define a repeating conductive geometry that forms the first mesh phase 206 and the second mesh phase 208. In preferred implementations, the mesh phases are interpenetrating and arranged in a chi-like pattern that yields repeated conductive paths, repeated node locations 210, and repeated diode-coupling nodes 212. The representative current paths 214 illustrate that current collected from the heavy-metal transduction layer can flow through multiple distributed paths rather than through a single unpatterned strip. This distribution contributes to effective impedance transformation and facilitates coupling to a distributed rectifier architecture.

The pitch dimension marker 216 and linewidth dimension marker 218 denote representative geometric design parameters of the chi-grid assembly 200. In a preferred implementation, the chi-patterned structure has a period of about 5 um and a linewidth of about 180 nm, although other periods and linewidths may be selected. The angular-offset marker 220 denotes a preferred angular offset associated with the chi-geometry. In optional or preferred RS-guided embodiments, this offset can be selected according to a phi-related angular relation. The isolation trench or overetch region 222 can be used to electrically isolate adjacent traces or regions of the conductive pattern. The peripheral conductor or bus regions 224 can be used to collect current from repeated local regions of the pattern and route that current toward output or rectification nodes.

In a representative preferred embodiment, the chi-grid assembly 200 is patterned from a 6 nm Pt layer and has a period of about 5 um, a linewidth of about 180 nm, and a total pattern depth of about 45 nm, including full Pt removal and an overetch of about 39 nm into an underlying spacer region so as to preserve electrical isolation between adjacent conductive traces. In preferred RS-guided embodiments, the angular-offset marker 220 corresponds to an angular offset of about phi/pi, approximately 0.515 rad or about 29.5 degrees. In a representative preferred geometry, the linewidth-to-period ratio gives a fill factor of about 180/5000=3.6 percent. The chi-grid may be understood as a repeated arrangement of counter-helical conductive traces forming two interpenetrating mesh phases at a preferred phi-related volumetric ratio.

The chi-grid assembly 200 performs more than a simple routing function. In the disclosed architecture, the chi-grid assembly 200 is configured as a functional impedance-transform structure. The geometry of the conductive traces, node density, distributed coupling points, and conductive path multiplicity can be selected such that an effective impedance associated with the chi-patterned structure approaches the desired rectifier load condition. In preferred implementations, the structure is selected or dimensioned so that a load-to-source impedance ratio r=Z_load/Z_source approaches a J-cost minimum under J(r)=0.5*(r+1/r)−1, where the minimum occurs at r=1. This relation may be used as a disclosed structural design doctrine for selecting period, linewidth, node density, conductive-path multiplicity, bus coupling, or other geometric features of the chi-patterned structure.

In a representative preferred embodiment, the chi-grid geometry transforms an unpatterned source impedance of about 67 ohms to an effective chi-grid impedance Z_chi of about 35 ohms by providing a plurality of parallel conductive paths and distributed collection nodes. In a corresponding preferred rectifier embodiment, the effective diode-array impedance is also about 35 ohms, giving a preferred matched condition J(Z_diode/Z_chi)=J(1)=0. Representative J-cost values illustrate the preferred matching doctrine: when r=1.0, J(r)=0 and transfer is maximal; when r=0.5 or 2.0, J(r)=0.25; when r=0.25 or 4.0, J(r)=1.125; and when r=0.1 or 10.0, J(r)=4.55. In a preferred implementation, the chi-grid is selected so that Z_chi/Z_diode is about 1.0+/−0.05 , keeping J below about 0.001 and corresponding to a preferred near-maximal transfer condition.

In preferred implementations, the chi-grid assembly 200 also provides a second functional role beyond impedance transformation. The counter-helical arrangement of the first counter-helical trace set 202 and the second counter-helical trace set 204 can be configured to suppress first-order perturbative field effects, including first-order magnetic or related field-coupling disturbances that would otherwise degrade or destabilize the collected signal. Thus, the chi-grid assembly 200 may be disclosed as a dual-function architecture: impedance transformation on the one hand, and first-order perturbation suppression through counter-helical conductive-path structure on the other hand. This dual-function description is particularly useful for supporting fallback claim positions and for distinguishing the disclosed pattern from purely decorative or arbitrary conductor layouts.

The node locations 210 and diode-coupling nodes 212 can be selected according to rectifier-placement strategy, diode area, barrier thickness, fabrication alignment tolerance, and desired local current density. In some implementations, each diode-coupling node 212 is coupled to one diode or diode cluster. In other implementations, a subset of node locations 210 may be combined into shared rectifier regions or routed to bus structures for regional current collection prior to rectification. The specific coupling architecture may vary without changing the fundamental role of the chi-grid assembly 200 as the collection and impedance-transform stage of the harvester.

If multiple candidate chi-grid geometries are available, selection among those geometries can be guided by one or more refinement criteria. In preferred implementations, a candidate geometry is favored if it reduces J(r), improves coupling to the intended rectifier impedance, preserves electrical isolation between adjacent traces or nodes, remains manufacturable within linewidth and pitch tolerances, preserves conformal integrity of the overall laminate, and, where desired, preserves the counter-helical path arrangement associated with first-order perturbation suppression. The disclosed geometry-selection logic therefore supports both physical fabrication design and claim support for structurally guided matching architectures.

The chi-grid assembly 200 shown in FIG. 2 may be patterned directly from the heavy-metal transduction layer or may be formed from a conductive structure integrated with that layer. In preferred embodiments, the chi-grid assembly 200 is patterned from the same heavy-metal layer that performs ISHE transduction, thereby integrating transduction, collection, impedance transformation, and rectifier coupling within a compact thin-film architecture. In alternative embodiments, one or more auxiliary conductive features can be added while preserving the chi-patterned collection and matching function.

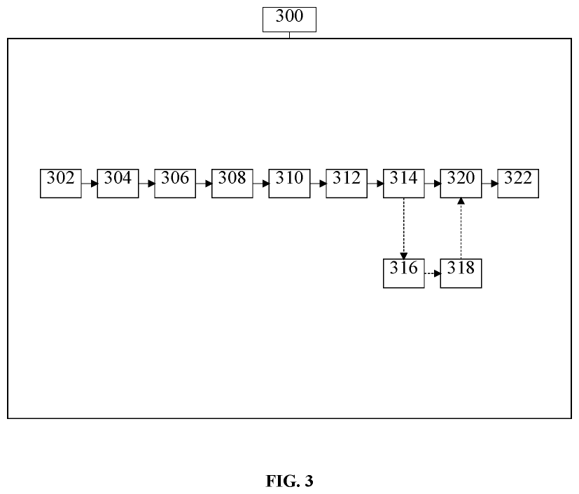

FIG. 3 is a schematic functional diagram of a representative conversion workflow 300 for the disclosed harvester. The conversion workflow 300 can include a thermal-gradient input 302, a spin-current generation stage 304, a spin-current transfer interface 306, an inverse-spin-Hall conversion stage 308, a chi-grid collection stage 310, an impedance-transformation stage 312, a zero-bias rectification stage 314, an optional accumulation stage 316, an optional regulation stage 318, a DC output stage 320, and a load or powered device 322. The workflow 300 is intended to illustrate the staged thermal-to-spin-to-charge-to-rectified-DC operation of the disclosed architecture and may be implemented in the physical stack shown in FIG. 1 and the chi-patterned geometry shown in FIG. 2.

At the thermal-gradient input 302, a temperature differential is established across the ferrimagnetic layer of the device. The source of the thermal gradient can be any surface, fluid-carrying structure, process enclosure, duct, pipe, manifold, exchanger, or other heat-bearing body that maintains a temperature difference across the thickness of the ferrimagnetic layer or across the overall active stack. In some implementations, the gradient is produced by direct contact with a hot surface and passive exposure to a cooler ambient region. In other implementations, spacers, thermal spreaders, or packaging elements may be used to maintain or shape the gradient. The disclosed architecture does not require a single particular heat-source type so long as a usable thermal differential is presented to the spin-Seebeck layer.

At the spin-current generation stage 304, the ferrimagnetic insulator responds to the thermal-gradient input 302 by generating a spin current under the longitudinal spin-Seebeck effect. The resulting spin current may be represented by a spin-current density J_s and may depend on one or more factors including the magnitude of the temperature gradient, the selected ferrimagnetic material, film thickness, interface quality, and operating temperature range. In preferred embodiments, the ferrimagnetic material comprises Co2Y hexaferrite, although other ferrimagnetic materials may be used as described elsewhere herein. The spin-current transfer interface 306 represents the boundary or coupling region through which the spin current is transferred from the ferrimagnetic layer into the adjacent heavy-metal transduction layer. At the inverse-spin-Hall conversion stage 308, the heavy-metal layer converts the received spin current into a charge voltage through the inverse spin Hall effect. In preferred embodiments, the heavy-metal layer comprises Pt. In other embodiments, other heavy metals may be used. The resulting charge signal can be characterized by an inverse-spin-Hall voltage V_ISHE. In representative implementations, V_ISHE may be modeled or estimated using a relation such as V_ISHE=theta_SH*rho*l*J_s, where theta_SH represents a spin-Hall response term, rho represents resistivity, l represents a channel dimension, and J_s represents the received spin-current density. Such relations are disclosed as useful design and validation tools and should not be read as limiting unless expressly recited.

At the chi-grid collection stage 310, the transduced charge is received into a chi-patterned conductive architecture that distributes, collects, and routes the signal through repeated conductive paths and node locations. The chi-grid collection stage 310 may be implemented by the chi-patterned conductive region described with respect to FIGS. 1 and 2. The collection stage can include repeated local coupling regions, repeated node positions, bus structures, or distributed conductive paths that enable routing of the transduced signal toward one or more rectification sites. By distributing collection through a repeated pattern rather than relying on a single simple strip conductor, the disclosed architecture supports local rectifier coupling and effective impedance transformation within the device itself.

At the impedance-transformation stage 312, the effective electrical behavior of the chi-patterned structure is shaped toward the loading condition presented by the rectification stage. In preferred embodiments, the effective matching condition is analyzed through the ratio r=Z_load/Z_source, where Z_source can correspond to an effective source impedance associated with the transduction and collection structure and Z_load can correspond to the effective diode or downstream rectifier load. In preferred embodiments, the structure is selected or refined under the relation J(r)=0.5*(r+1/r)−1, which reaches a minimum at r=1. Candidate geometries may therefore be selected to reduce J(r), improve source-to-load transfer efficiency, and preserve manufacturable geometries and coupling densities. This stage may also include the preferred counter-helical path arrangement discussed above, which can provide first-order perturbation suppression while the same patterned structure performs impedance transformation.

At the zero-bias rectification stage 314, one or more zero-bias tunnel diodes receive the collected and impedance-shaped signal and convert that signal into DC output. In preferred embodiments, the zero-bias rectification stage 314 includes MIM tunnel diodes, including preferred Ti/Al2O3/Al examples. The rectification stage may be distributed over a plurality of coupling nodes, implemented in clusters, or arranged in local regions of the active device according to layout preference, current density, and fabrication tolerance. The output of the rectification stage may be characterized by a rectified power P_DC and by an overall rectification efficiency eta_rect. In a representative relation, rectified output may be estimated using P_DC=eta_rect*V_ISHE\hat{ }2/(4*Z_chi), where Z_chi represents an effective impedance associated with the chi-patterned structure. Again, such expressions are disclosed as representative design and validation tools and should not be read as limiting unless expressly claimed.

The optional accumulation stage 316 and optional regulation stage 318 represent downstream electrical processing that may be used in some, but not all, implementations. In some embodiments, the rectified signal from the zero-bias rectification stage 314 is delivered directly to the DC output stage 320 and then to the load or powered device 322. In other embodiments, energy is first accumulated, quantized, stored, boosted, regulated, or otherwise conditioned before delivery. Thus, the load or powered device 322 may be powered directly or indirectly depending on the use case, the duty cycle, the available thermal gradient, and the target electrical behavior. These optional stages should be understood as downstream processing layers that do not alter the core thermal-to-spin-to-charge rectifying mechanism of the harvester.

The conversion workflow 300 may also be understood as a claim-support map for the method aspects of the invention. In a representative method, a thermal gradient is applied across a ferrimagnetic layer, a spin current is generated in response to that gradient, the spin current is converted into a charge voltage in a heavy-metal layer, the charge is collected and impedance-transformed by a chi-patterned conductive structure, and the collected signal is rectified through zero-bias tunnel diodes to produce DC output. Optional accumulation, regulation, storage, and load-delivery operations may follow, but need not be required in the broadest method claims.

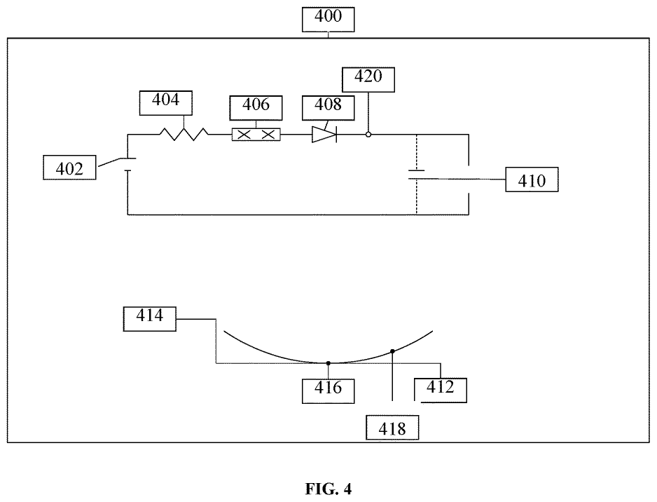

FIG. 4 is a schematic electrical and matching diagram of a representative electrical model 400 for the disclosed harvester. The electrical model 400 can include a source voltage node 402, a source impedance 404, a chi-grid effective impedance 406, a rectifier load 408, an optional storage or load branch 410, a matching-ratio definition 412, a J-cost relation annotation 414, a preferred matched condition 416, a mismatched condition example 418, and an output node 420. The electrical model 400 is schematic and is intended to illustrate preferred matching and transfer relations within the disclosed harvester rather than to limit the device to one exact circuit topology.

The source voltage node 402 represents the transduced electrical signal arising from inverse-spin-Hall conversion in the heavy-metal layer. The source impedance 404 represents an effective source-side impedance associated with the transduction layer and the immediate collection architecture. In an unpatterned or differently patterned system, this impedance may not be well matched to the load presented by a zero-bias rectifier. The chi-grid effective impedance 406 represents the effective impedance presented by the chi-patterned collection structure, which in the disclosed architecture serves as a functional impedance-transform layer between the transduction stage and the rectifier load 408. The output node 420 represents the rectified output or a downstream node at which electrical power is delivered, accumulated, or conditioned.

The matching-ratio definition 412 represents the relation r=Z_load/Z_source, which may be used to compare the effective load presented by the rectifier load 408 to the effective source-side behavior seen through the chi-grid effective impedance 406. In preferred implementations, the disclosed architecture is refined under the J-cost relation shown by the J-cost relation annotation 414, where J(r)=0.5*(r+1/r)−1. This relation reaches a minimum at r=1 and is strictly nonnegative for positive r. Accordingly, the preferred matched condition 416 corresponds to a condition in which the effective load-to-source ratio approaches unity or near unity under the selected design model. The mismatched condition example 418 represents a less desirable condition in which the effective ratio deviates materially from unity, thereby increasing J(r) and reducing preferred transfer behavior.

The electrical model 400 is useful for design selection, refinement, and validation. In one example, a designer may determine or estimate the source impedance 404 associated with a chosen ferrimagnetic/heavy-metal stack, determine or estimate the rectifier load 408 associated with a chosen diode array or diode cluster, and then select the chi-grid effective impedance 406 through geometric pattern design so that the effective ratio r approaches the preferred matched condition 416. Candidate design changes can include altering trace multiplicity, node density, period, linewidth, bus architecture, or local coupling strategy. The disclosed J-cost matching doctrine therefore provides a structural design rule for selecting among multiple pattern geometries instead of relying solely on trial-and-error tuning.

The chi-grid effective impedance 406 should be understood as more than a passive series or parallel resistor substitute. Because the chi-patterned structure is distributed over the active area and may include repeated conductive paths and repeated rectifier-coupling nodes, its effective impedance may arise from geometry, path multiplicity, distributed current routing, localized collection, and node-level coupling behavior. Thus, the electrical model 400 is an abstraction of the physical architecture, and the chi-grid effective impedance 406 can be interpreted as the net matching behavior emerging from the disclosed patterned structure rather than only as a lumped component inserted after transduction.

In preferred implementations, the electrical model 400 may also include the optional storage or load branch 410. This branch may represent direct load delivery, temporary accumulation, switched-capacitor extraction, regulated delivery, storage in a capacitor or thin-film battery, or power supply to a sensor, telemetry module, controller, or other downstream device. The optional storage or load branch 410 is therefore included to show that the rectified output can be used in multiple downstream ways while preserving the central role of the chi-grid effective impedance 406 and the rectifier load 408 in setting the source-side matching condition.

The electrical model 400 also supports fallback claim positions. In particular, the model supports claims directed to:
(1) transforming effective source impedance toward a rectifier load;
(2) selecting chi-grid geometry under the J(r) relation;
(3) operating near a matched or near-matched condition;
and
(4) providing a structurally motivated matching architecture within the harvester itself. These claim-support positions are valuable because they emphasize that the disclosed chi-pattern is not arbitrary ornamentation but part of the device's electrical operating logic.

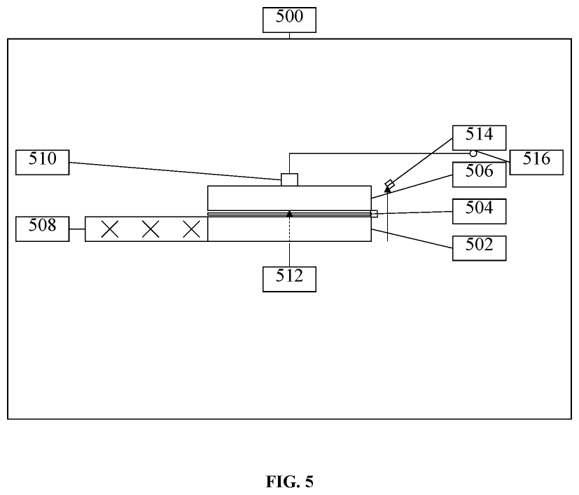

FIG. 5 is a schematic cross-sectional detail view of a representative rectifier region 500 integrated with a chi-patterned conductive structure. The rectifier region 500 can include a lower electrode 502, a tunnel barrier 504, an upper electrode 506, a chi-grid connection region 508, a diode contact 510, a representative tunneling path 512, a built-in potential direction 514, and a rectified output node 516. The rectifier region 500 may represent one diode, one diode cell, one diode site, or one element of a larger diode array distributed across the active harvester surface. The drawing is schematic and not necessarily to scale.

The lower electrode 502 and upper electrode 506 are separated by the tunnel barrier 504 so as to form a zero-bias tunnel rectifier. In preferred embodiments, the lower electrode 502 comprises Ti, the tunnel barrier 504 comprises Al2O3, and the upper electrode 506 comprises Al. Other metal-insulator-metal combinations may be used provided that the resulting structure provides the desired zero-bias rectification behavior. The representative tunneling path 512 illustrates charge transport through the tunnel barrier 504, and the built-in potential direction 514 indicates the preferred asymmetry or internal bias condition arising from the work-function relationship of the electrode stack.

The chi-grid connection region 508 represents the coupling location at which the chi-patterned conductive structure electrically feeds the rectifier region 500. In some implementations, the diode contact 510 may be localized at a node or junction in the chi-pattern. In other implementations, the rectifier may be coupled through a short local conductor, a pad region, or a bus feature derived from the chi-grid geometry. The rectified output node 516 represents the node at which rectified current or voltage is delivered from the rectifier region 500 to a downstream conductor, output rail, accumulation element, or load.

The rectifier region 500 is strategically important because it enables on-device or in-stack rectification without requiring an external bias circuit. In contrast to architectures that merely generate an electrical signal and then rely on remote or bulky downstream electronics for conversion, the disclosed harvester integrates rectification into the harvesting structure itself. This integrated zero-bias rectification is one of the principal differentiators of the preferred architecture and supports both compact packaging and reduced parasitic losses associated with external interconnects and off-device conversion hardware.

In a representative preferred rectification embodiment, the lower electrode 502 comprises Ti at about 50 nm thickness, the tunnel barrier 504 comprises Al2O3 at about 1.8 nm thickness, and the upper electrode 506 comprises Al at about 50 nm thickness. The work-function asymmetry of the stack produces a preferred built-in potential on the order of about 50 mV, enabling zero-bias rectification of the collected ISHE signal. In one preferred performance model, rectification efficiency may be represented as eta_rect=eta_diode*eta_match*eta_coupling, where eta_diode is about 0.55, eta_match is about 0.99 for a preferred J-cost-matched condition, and eta_coupling is about 0.77, giving eta_rect about 0.42. Using V_ISHE about 94 mV and Z_chi about 35 ohms, a representative rectified output per diode cluster is P_DC=eta_rect*V_ISHE\hat{ }2/(4*Z_chi), which yields approximately 26.5 uW per diode cluster. At a representative density of about 68 diode clusters per cm\hat{ }2 for a 5 um chi-grid pitch, the resulting preferred power density is about 1.80 mW/cm\hat{ }2.

The geometry, area, and barrier thickness of the rectifier region 500 can be selected according to the available signal magnitude, local current density, impedance target, fabrication capability, and desired rectification efficiency. In some implementations, a single rectifier region 500 may be associated with a single chi-grid node or local cluster of nodes. In other implementations, multiple diode structures can be placed in an array or network over the device area to receive the collected signal from repeated coupling locations. The disclosed architecture therefore supports one-to-one, one-to-many, or many-to-one coupling relationships between patterned conductive regions and rectifier structures.

Refinement of the rectifier region 500 may include altering diode area, altering barrier thickness, altering electrode material, altering node density in the upstream chi-grid, or altering the local coupling arrangement between the chi-grid connection region 508 and the diode contact 510. If rectification is weaker than desired, these variables may be changed alone or together so as to improve local coupling efficiency, diode impedance compatibility, and overall harvested output. Thus, the rectifier region 500 should be understood not as an isolated diode drawing but as a representative local implementation of a broader distributed rectification architecture integrated with the chi-patterned collection layer.

In preferred implementations, the rectifier region 500 participates in the broader matching doctrine described with respect to FIG. 4. That is, the effective impedance of the rectifier region 500 or of a distributed rectifier array including a plurality of such regions may be coordinated with the effective source-side behavior of the chi-patterned conductive structure so that the overall load-to-source ratio approaches a preferred matched or near-matched condition. Accordingly, the rectifier structure and the chi-grid structure are disclosed together not merely because they are electrically connected, but because they cooperate in setting the effective harvesting and transfer behavior of the integrated device.

In a representative preferred measured-and-modeled embodiment, the unpatterned Pt film presents an internal resistance of about 66.7 ohms, the chi-grid transforms that effective source behavior to about Z_chi=35 ohms, the tunnel-diode array presents an effective impedance of about 35 ohms, the resulting matching condition corresponds to J near zero, and the integrated structure produces about 42 percent rectification efficiency and about 1.80 mW/cm\hat{ }2 at Delta T=90 K. These values are useful because they tie together the preferred stack architecture, the preferred geometric pattern, the preferred matching doctrine, and the preferred rectification outcome in one concrete disclosed embodiment.

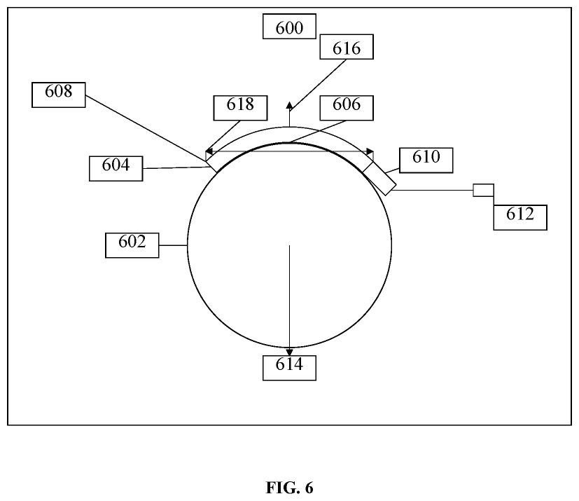

FIG. 6 is a schematic side view of a representative installed system 600 in which the disclosed harvester is configured as a conformal laminate mounted on a curved thermal surface. The installed system 600 can include a curved thermal surface 602, a harvester laminate 604, an adhesive layer 606, an encapsulation layer 608, a flex interconnect 610, an output cable or connector 612, a bend-radius indicator 614, an ambient side 616, and a mounting span 618. The figure illustrates one preferred packaging and deployment mode for the disclosed harvester and should be understood as schematic rather than to scale.

The curved thermal surface 602 may be any heat-bearing host surface from which waste heat is to be harvested. Representative examples include outer surfaces of pipes, manifolds, ducts, condensers, vessels, housings, exchangers, and other process components that maintain a usable thermal gradient between the host surface and the surrounding environment. The harvester laminate 604 is positioned so that its active thermal-to-electrical stack is thermally coupled to the curved thermal surface 602 while an opposite side of the laminate is exposed, directly or indirectly, to the ambient side 616 or another lower-temperature boundary. This arrangement enables the establishment of a thermal gradient across the active stack during installed operation.

The harvester laminate 604 can include the active layered architecture described above with respect to FIGS. 1 through 5, including the ferrimagnetic spin-Seebeck layer, the heavy-metal inverse-spin-Hall layer, the chi-patterned conductive structure, and the zero-bias rectification layer or layers. In preferred implementations, the harvester laminate 604 is sufficiently thin and compliant to conform to the contour of the curved thermal surface 602 without losing operative contact or causing unacceptable strain in the active layers. The bend-radius indicator 614 is included to show that the laminate may be characterized by a minimum bend radius or other conformal-installation criterion. The precise allowable bend radius may vary according to layer thickness, substrate choice, encapsulation selection, and installation conditions.

The adhesive layer 606 can be used to mount the harvester laminate 604 directly to the curved thermal surface 602. In preferred implementations, the adhesive layer 606 comprises a pressure-sensitive adhesive that provides both mechanical retention and good enough thermal contact to support the desired gradient across the active stack. The encapsulation layer 608 can protect the active device from environmental exposure, moisture ingress, mechanical abrasion, or electrical shorting while still permitting practical deployment of a thin-film laminate. In some implementations, openings, vias, or local access regions may be provided through the encapsulation layer 608 to allow connection to the flex interconnect 610, the output cable or connector 612, or other downstream conductive features.

The flex interconnect 610 and the output cable or connector 612 represent representative downstream electrical interfaces by which rectified output is routed from the installed harvester to accumulation circuitry, regulation circuitry, storage elements, sensors, telemetry modules, controllers, or other loads. In some implementations, the flex interconnect 610 may terminate at a local sensor node physically adjacent the curved thermal surface 602. In other implementations, the flex interconnect 610 may route power to a more remote electronics package. The installed system 600 therefore supports both integrated local-power deployments and distributed-output architectures.

FIG. 6 is important in showing that conformal packaging is a preferred deployment mode of the invention, but it should not be read as narrowing the broadest device claims to adhesive-backed or curved-surface-only implementations. Rather, FIG. 6 supports strong fallback positions directed to flexible, conformal, peel-and-stick, or curved-surface-mountable waste-heat harvesters. In preferred embodiments, however, the conformal-laminate form factor is a commercially important feature because it allows the device to be mounted on surfaces for which rigid modules are poorly suited.

In use, the installed system 600 may be selected so that the mounting span 618 covers a surface region having a suitable local thermal gradient, curvature, and available area. A larger mounting span 618 may support greater aggregate collected power through increased active area, whereas a smaller mounting span 618 may be selected for a compact local sensor application. Thus, FIG. 6 supports both device-level and system-level claim positions related to conformal deployment, surface-mountable waste-heat recovery laminates, and locally powered monitoring architectures.

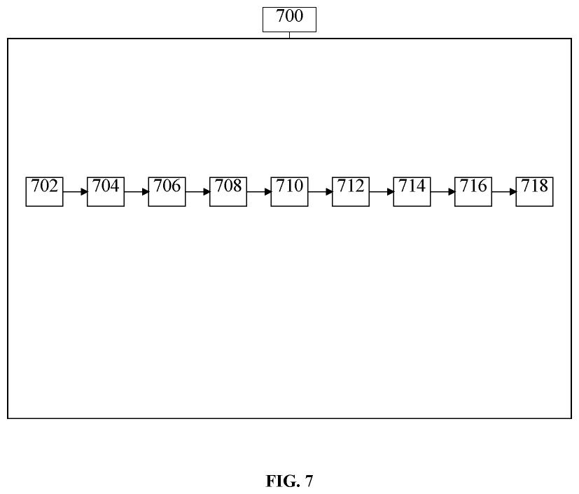

FIG. 7 is a process-flow diagram of a representative fabrication workflow 700 for producing the disclosed harvester. The fabrication workflow 700 can include a substrate-preparation stage 702, a ferrimagnetic-layer deposition stage 704, a heavy-metal-layer deposition stage 706, a chi-grid-patterning stage 708, a diode-formation stage 710, an encapsulation stage 712, a lamination stage 714, an inspection or metrology stage 716, and a finished-device output 718. The order shown is representative and may be modified in some embodiments so long as the disclosed structural relationships are preserved.

At the substrate-preparation stage 702, a substrate suitable for supporting the active stack is selected, formed, cleaned, prepared, or conditioned. In a preferred embodiment, the substrate comprises a muscovite mica sheet that is cleaved to a desired thickness and cleaned before deposition. Representative preparation operations can include solvent cleaning, drying, surface inspection, roughness measurement, and other conditioning operations directed to obtaining a suitable deposition surface. In alternative embodiments, the substrate-preparation stage 702 may include preparation of a polymeric film, ceramic support, composite support, or other alternative substrate. The substrate-preparation stage 702 therefore supports both the preferred mica embodiment and broader substrate families disclosed elsewhere herein.

In a representative preferred fabrication sequence, substrate preparation includes cleaving muscovite mica to about 40 um sheets, cleaning by ultrasonic treatment in acetone for about 5 minutes, IPA for about 5 minutes, and DI water, followed by N2 drying and a hotplate dry at about 120 C for about 5 minutes. In preferred implementations, surface inspection may include AFM verification of RMS roughness below about 0.5 nm. For ferrimagnetic deposition, a preferred Co2Y layer may be formed by aerosol-assisted chemical vapor deposition using Co(acac)3, Ba(acac)2, and Fe(acac)3 precursors dissolved in acetylacetone at about 0.1 M concentration, with a representative substrate temperature of about 950 C, a deposition time of about 30 minutes at about 10 um/hr, and a post-anneal at about 800 C for about 2 hours in O2. In a preferred heavy-metal deposition stage, Pt may be deposited by e-beam evaporation at about 200 C substrate temperature to a thickness of about 6 nm, optionally with an about 0.5 nm Ti seed layer, followed by sheet-resistance verification of about 66 ohm/sq. In a representative chi-grid patterning stage, ZEP-520A resist may be spin-coated to about 250 nm and baked at about 180 C for about 3 minutes, exposed by e-beam lithography at about 220 uC/cm\hat{ }2, developed in n-amyl acetate for about 60 seconds, etched by Ar ion milling for about 30 seconds, and stripped by O2 plasma at about 100 W for about 2 minutes, with representative linewidth uniformity of about 1 sigma=6.4 nm across a 200 mm wafer. In a representative diode-formation stage, Ti may be deposited to about 50 nm through a shadow mask, Al2O3 may be formed by about 9 ALD cycles at about 200 C, and Al may be deposited to about 50 nm through a second mask, with representative diode area about 100 nm×100 nm and source-reported yield above about 95 percent. Encapsulation may include about 4 um parylene-C, pad opening by excimer laser ablation, and wire bonding by Al wedge bonds to a flex PCB.

At the ferrimagnetic-layer deposition stage 704, a ferrimagnetic material is deposited onto the prepared substrate to form the spin-Seebeck layer. In a preferred embodiment, the ferrimagnetic layer comprises Co2Y hexaferrite deposited by aerosol-assisted chemical vapor deposition. Representative process variables can include precursor selection, concentration, substrate temperature, deposition time, deposition rate, post-deposition anneal temperature, anneal duration, and oxygen environment. In alternative embodiments, other ferrimagnetic materials and other deposition methods may be used. The ferrimagnetic-layer deposition stage 704 should be described with enough process detail to support a real make-and-use disclosure rather than a purely conceptual description.

At the heavy-metal-layer deposition stage 706, a heavy-metal layer is formed on the ferrimagnetic layer so as to enable inverse-spin-Hall conversion of the generated spin current. In a preferred embodiment, the heavy-metal layer comprises Pt deposited to a thickness of about 6 nm. Representative deposition methods can include e-beam evaporation, sputtering, or other thin-film deposition techniques. In some implementations, an adhesion-promoting seed layer may be provided between the ferrimagnetic layer and the heavy-metal layer or between the heavy-metal layer and a subsequent structure. The heavy-metal-layer deposition stage 706 may also include sheet-resistance verification, thickness metrology, or related characterization to ensure that the resulting layer supports the intended transduction and matching behavior.

At the chi-grid-patterning stage 708, the heavy-metal layer is patterned into the chi-geometry described above. This stage is important because it establishes an explicit process relationship between heavy-metal deposition and chi-pattern formation. In preferred embodiments, the heavy-metal layer itself is patterned into the chi-grid before or in conjunction with subsequent rectifier integration. Representative patterning operations can include resist coating, lithographic exposure, imprinting, development, etching, overetch or trench formation, and resist stripping. In preferred embodiments, the patterning stage establishes period, linewidth, node locations, conductive path multiplicity, and isolation between adjacent conductive regions. This stage therefore supports both the preferred geometry and broader fabrication and process claims directed to forming the heavy-metal layer as a chi-patterned impedance-transform structure.

At the diode-formation stage 710, one or more zero-bias tunnel rectifiers are formed and electrically coupled to the chi-patterned conductive structure. In preferred embodiments, the diode-formation stage 710 includes formation of a lower electrode, a thin tunnel barrier, and an upper electrode to create a MIM tunnel diode, including preferred Ti/Al2O3/Al examples. Representative formation techniques can include directional deposition, atomic-layer deposition for the barrier, shadow-mask patterning, aligned metallization, or other local-structure fabrication methods. The diode-formation stage 710 should make clear that rectifier integration is not an afterthought added far downstream, but an integrated formation stage of the disclosed harvesting stack.

At the encapsulation stage 712, the active device may be coated, sealed, or otherwise protected with one or more encapsulation layers. In preferred embodiments, a conformal protective coating is applied over the active device area while preserving access to contact pads or output regions. The encapsulation stage 712 may be selected to improve mechanical durability, moisture resistance, electrical insulation, and field deployability without materially degrading thermal or electrical performance of the active stack.

At the lamination stage 714, the completed device may be provided with an adhesive backing, carrier layer, mounting layer, protective handling layer, or other packaging feature that allows the active stack to be deployed as a laminate. This stage may include application of a pressure-sensitive adhesive, cutting or singulation of the active sheet, formation of a flex tail, or attachment of one or more interconnect structures. In preferred embodiments, the lamination stage 714 yields a device suitable for direct mounting on a curved thermal surface. In alternative embodiments, the lamination stage 714 may be omitted, modified, or replaced by another packaging operation depending on the intended deployment.

The inspection or metrology stage 716 may occur at one or more points in the fabrication workflow 700 rather than only at the end. Representative inspection and characterization operations can include thickness measurement, roughness measurement, XRD phase verification, VSM magnetization verification, sheet-resistance measurement, linewidth uniformity measurement, continuity testing, isolation testing, diode-yield testing, and alignment verification between rectifier features and chi-grid node locations. Such operations may be used as acceptance criteria, process-monitoring tools, or validation checkpoints for preferred manufacturing implementations.

The finished-device output 718 represents a completed harvester suitable for direct use, integration into a downstream system, packaging as a laminate product, or further combination with accumulation, regulation, sensing, or telemetry hardware. FIG. 7 therefore supports fabrication-method claims, process-refinement disclosure, and written-description support for the practical manufacture of the disclosed device. The fabrication workflow 700 further reinforces that the invention is enabled as a layered physical system with concrete process steps rather than only as a conceptual conversion chain.

In a representative preferred numerical example at Delta T=90 K, a 5 um Co2Y ferrimagnetic layer on a 40 um mica substrate is combined with a 6 nm Pt heavy-metal layer, a chi-grid having a 5 um period and 180 nm linewidth, and Ti/Al2O3/Al tunnel diodes having a preferred rectification efficiency of about 42 percent. Under these conditions, grad(T)=90/(5*10\hat{ }−6)=1.8*10\hat{ }7 K/m, J_s=(52*10\hat{ }−6)*(1.8*10\hat{ }7)=936 A/m\hat{ }2, and V_oc scales to about 94 mV in the preferred source-reported embodiment. Using P=eta_rect*V_oc\hat{ }2/(4*Z_chi) with eta_rect about 0.42 and Z_chi about 35 ohms yields a preferred power density of about 1.80 mW/cm\hat{ }2. At Delta T=30 K, V_oc scales approximately linearly to about 31.3 mV and power scales approximately quadratically to about 0.20 mW/cm\hat{ }2. At Delta T=250 K, V_oc scales to about 261 mV and power density scales to about 13.9 mW/cm\hat{ }2. At fixed Delta T=90 K and area 3000 cm\hat{ }2, total output is about 5.4 W, whereas at 300 cm\hat{ }2 the corresponding output is about 0.54 W. In additional preferred implementations, the harvester produces a power density of at least 1.5 mW/cm\hat{ }2 when a temperature gradient of 90 K is applied across the ferrimagnetic insulator layer. In further preferred implementations, the harvester produces an open-circuit voltage of at least 80 mV under the same temperature-gradient condition, and the rectification stage provides a rectification efficiency of at least 35 percent when the chi-patterned conductive structure is impedance-matched to the zero-bias tunnel rectifiers. In still further preferred implementations, the harvester maintains power output within 4 percent after 1000 thermal cycles between 0 C and 180 C and resists delamination after exposure to 120 C and 90 percent relative humidity for at least 500 hours. These representative examples are provided to illustrate make-and-use disclosure, scaling behavior, and preferred device performance and should not be read as limiting.

In one comparative embodiment, an otherwise identical device is fabricated with an unpatterned heavy-metal layer (no chi-pattern) and the same tunnel-diode array coupling. Under the same temperature gradient and area, the unpatterned device exhibits a higher effective source impedance at the rectifier coupling node(s) and reduced delivered rectified power relative to the chi-patterned device, consistent with the geometry-driven impedance transformation and distributed coupling described herein.

Unless otherwise stated, power density is measured as rectified DC electrical power delivered to a specified load impedance divided by active device area, with the temperature gradient applied across the ferrimagnetic layer thickness. Open-circuit voltage is measured at the rectifier input node(s) with the rectifier electrically disconnected. Rectification efficiency is computed as DC power delivered to the load divided by the available transduced electrical power at the rectifier input under the same thermal condition. Thermal cycling is performed by cycling between stated temperatures with a dwell time sufficient to reach thermal equilibrium at each extreme, and output is measured at a specified reference gradient before and after cycling. Humidity exposure is performed at stated temperature and relative humidity for the stated duration with periodic inspection for delamination and output degradation.

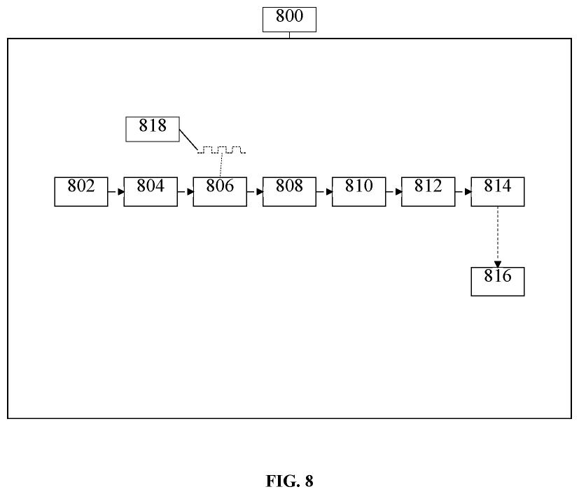

FIG. 8 is a block diagram of an optional power-conditioning system 800 that may be used downstream of the rectification stage in some embodiments. The power-conditioning system 800 can include a rectified input 802, a switched-capacitor accumulator 804, a release-control block 806, a storage element 808, a voltage regulator 810, a regulated output rail 812, a sensor node or load 814, an optional telemetry block 816, and an optional quantized-release annotation 818. FIG. 8 supports optional output accumulation, quantized release, regulation, and downstream power-delivery architectures and should be treated as optional to the broadest core claims unless expressly recited.

The rectified input 802 represents the DC signal delivered from the integrated harvesting and rectification architecture described above. In some embodiments, the rectified input 802 may be delivered directly to a load. In other embodiments, the rectified input 802 is delivered first to the switched-capacitor accumulator 804 or to another accumulation or storage structure. The switched-capacitor accumulator 804 represents a preferred optional embodiment in which harvested energy is accumulated prior to release, smoothing, regulation, or quantized transfer. In some embodiments, the switched-capacitor accumulator 804 may be configured according to a phi-ratio architecture, although other accumulation structures may also be used.

The release-control block 806 may determine when accumulated energy is released from the switched-capacitor accumulator 804 to the storage element 808, the voltage regulator 810, the regulated output rail 812, or the sensor node or load 814. In optional RS-guided embodiments, the release-control block 806 may operate according to a quantized extraction protocol in which energy is released in integer multiples of E_coh or according to an eight-tick or ledger-neutral release logic. The optional quantized-release annotation 818 indicates that the release event may be structured by a quantized control criterion rather than by arbitrary analog discharge alone. These optional architectures provide a disclosed strategic flank for accumulation and extraction claims without changing the core thermal-to-electrical harvesting mechanism.

In a representative preferred optional extraction embodiment, E_coh=phi\hat{ }−5 is approximately 0.090 eV or about 1.44*10\hat{ }−20 J, and the least-significant extraction unit of the switched-capacitor accumulator 804 is set equal to that quantity. In such embodiments, energy is released only when the accumulated energy reaches an integer multiple n*E_coh, where n is an integer greater than or equal to 1. In preferred ledger-neutral embodiments, the release condition is coordinated with eight-tick phase balance represented by sum_{k=0}\hat{ }{7} exp(2pii*k/8)=0. Representative output rails may include regulated 1.8 V or 3.3 V outputs, and preferred quiescent current may be less than about 50 nA in a self-powered implementation.

The storage element 808 may comprise one or more capacitors, thin-film batteries, microbatteries, supercapacitors, or other local energy stores. The voltage regulator 810 may comprise any suitable regulation circuit for producing a desired output level at the regulated output rail 812. The regulated output rail 812 can then supply the sensor node or load 814, which may include a sensing device, a controller, a processor, a transmitter, a memory element, a monitoring circuit, or another powered component. In some implementations, the optional telemetry block 816 is coupled to the sensor node or load 814 and uses harvested energy to communicate data, status, or measurements to a remote receiver.

FIG. 8 should be understood as supporting optional downstream electrical architectures rather than redefining the core identity of the invention. The broadest embodiments of the disclosed harvester do not require switched-capacitor accumulation, quantized release, storage, or regulation. However, in preferred optional implementations, these downstream stages can be used to improve duty-cycle compatibility, stabilize output, supply intermittent loads, support sensing and telemetry packages, or implement a preferred RS-guided extraction discipline. Accordingly, FIG. 8 supports system claims, optional dependent claims, and continuation-worthy claim families without making the broadest device and method claims unnecessarily narrow.

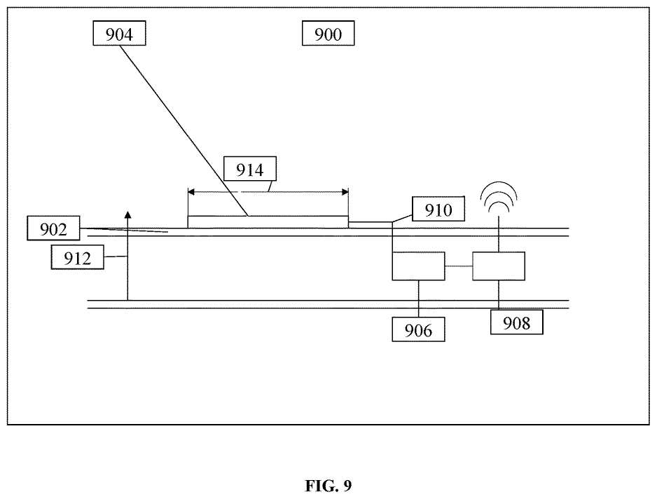

FIG. 9 is a schematic deployment view of a representative steam-pipe deployment 900 for the disclosed harvester. The steam-pipe deployment 900 can include a pipe wall 902, a harvester laminate 904, a sensor node 906, a wireless transmitter 908, an output lead 910, a local thermal-gradient region 912, and a mounting span 914. The steam-pipe deployment 900 illustrates one downstream implementation in which the disclosed harvesting architecture is mounted on a process pipe or similar thermal structure and used to supply electrical power to a monitoring or telemetry package. The deployment shown is illustrative and should not be understood as limiting the device only to steam pipes or only to cylindrical geometries.

In the illustrated embodiment, the pipe wall 902 provides a heated host surface establishing the local thermal-gradient region 912 across the active device stack of the harvester laminate 904. The harvester laminate 904 can comprise the same core architecture described above, including the ferrimagnetic spin-Seebeck layer, the heavy-metal inverse-spin-Hall transduction layer, the chi-patterned collection and impedance-transform structure, and the integrated zero-bias rectification stage. The mounting span 914 indicates that the active device may extend over a selected surface length or arc of the pipe wall 902 according to available area, local curvature, installation constraints, and desired output level.

The output lead 910 represents one example of a power-delivery path from the harvester laminate 904 to the sensor node 906, the wireless transmitter 908, or another local or remote load. In some implementations, the sensor node 906 may monitor temperature, vibration, corrosion, pressure, flow-related conditions, or other parameters associated with the pipe or process system. The wireless transmitter 908 may then communicate the resulting measurements to a receiver, local controller, supervisory network, or plant monitoring system. Thus, FIG. 9 supports downstream system claims directed to self-powered monitoring packages while preserving the subordinate role of the deployment architecture relative to the core harvesting mechanism.

The steam-pipe deployment 900 may also be used to support scaled-output examples. In a representative embodiment, a smaller laminate area may provide power suitable for a local low-duty-cycle sensor or intermittent telemetry package, whereas a larger installed area may provide proportionally greater harvested output. For clarity of disclosure, scaled or projected output examples should distinguish between smaller-area and larger-area installations. For example, where the source-reported arithmetic indicates approximately 540 mW at 300 cm\hat{ }2 and approximately 5.4 W at 3000 cm\hat{ }2 under a nominal Delta T=90 K condition, those values should be kept distinct and not conflated. FIG. 9 therefore supports both physical deployment disclosure and properly framed example-based system scaling.

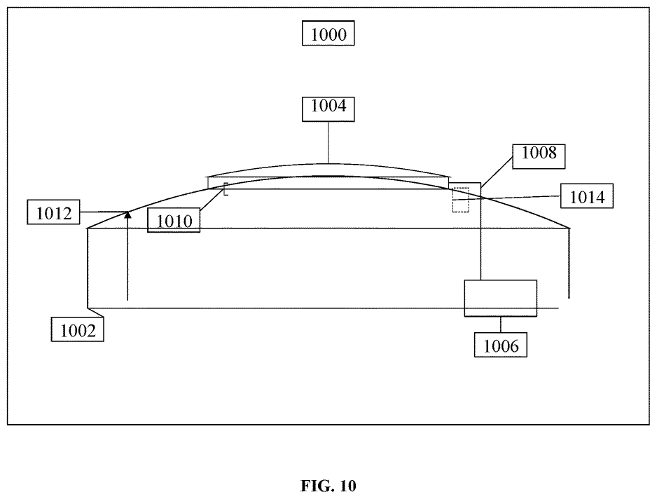

FIG. 10 is a schematic deployment view of a representative vehicle deployment 1000 in which the disclosed harvester is mounted on a hot manifold or similar vehicle thermal surface. The vehicle deployment 1000 can include a hot manifold surface 1002, a conformal harvester 1004, an electronics module 1006, an output lead 1008, an attachment region 1010, a thermal-gradient region 1012, and an optional shield or spacer 1014. The vehicle deployment 1000 supports downstream embodiments directed to exhaust-heat recovery, manifold-mounted sensing, or other localized high-gradient applications.

The hot manifold surface 1002 may comprise an exhaust manifold, turbocharger housing, EGR component, exhaust duct, or another engine-bay or drivetrain heat source. The conformal harvester 1004 can be mounted so that its active stack experiences a temperature differential across the thermal-gradient region 1012. In some implementations, the attachment region 1010 may include an adhesive layer, clamp-assisted retention feature, mechanical fastening region, or another mounting structure suited to the target environment. In some implementations, the optional shield or spacer 1014 may be used to manage local thermal exposure, vibration, abrasion, or clearance relative to nearby vehicle components.

The electronics module 1006 may include sensing, control, regulation, storage, or communication circuitry powered fully or partially by the conformal harvester 1004. The output lead 1008 can route harvested energy from the active harvester to the electronics module 1006 or to another downstream circuit. The vehicle deployment 1000 therefore supports a family of use embodiments in which the disclosed harvester is adapted for a compact, thermally aggressive environment while preserving the same core thermal-to-spin-to-charge-to-rectified-DC architecture described elsewhere herein. FIG. 10 is especially useful for supporting downstream vehicle-monitoring or exhaust-heat recovery claim positions, but it should not be read as altering the core identity of the device itself.

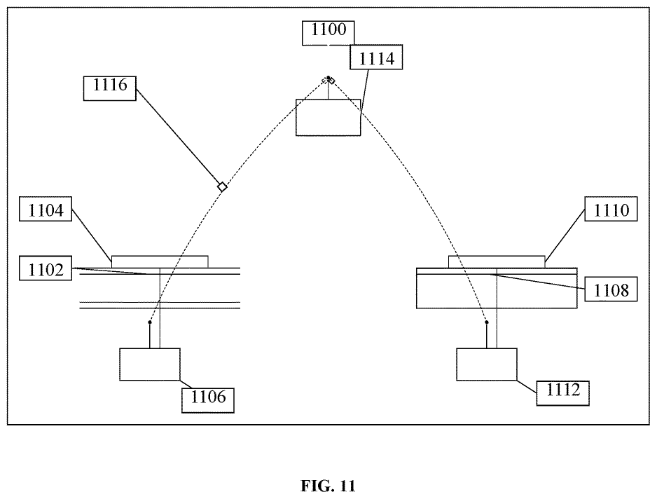

FIG. 11 is a schematic monitoring embodiment 1100 showing representative pipeline and HVAC deployments. The monitoring embodiment 1100 can include a pipeline segment 1102, a pipeline harvester 1104, a pipeline sensor package 1106, an HVAC surface 1108, an HVAC harvester 1110, an HVAC sensor package 1112, a central data aggregator 1114, and a wireless communication path 1116. FIG. 11 may be implemented as a multi-panel drawing in which one panel illustrates a pipeline embodiment and another panel illustrates an HVAC embodiment. The purpose of FIG. 11 is to show that the disclosed harvester may be incorporated into multiple downstream monitoring environments without changing its core layered operating mechanism.

In one panel, the pipeline segment 1102 may carry a heated fluid, and the pipeline harvester 1104 may be mounted on the exterior of the pipeline segment 1102 to generate electrical output from a resulting thermal gradient. The pipeline sensor package 1106 may then use the harvested power to support monitoring of corrosion, thickness, temperature, vibration, leak conditions, pig-passage conditions, or other pipeline-relevant parameters. In another panel, the HVAC surface 1108 may represent a condenser coil, line, plate, or housing, and the HVAC harvester 1110 may be mounted thereon to generate power for the HVAC sensor package 1112, which may monitor refrigeration, flow, pressure, vibration, compressor performance, or related conditions.

The wireless communication path 1116 indicates that one or more downstream sensing packages may communicate with the central data aggregator 1114 or another network endpoint. The central data aggregator 1114 may be local or remote and may collect output from multiple deployed harvesting-and-sensing nodes. FIG. 11 therefore supports downstream multi-node system claims and monitoring-network embodiments while still keeping the core harvesting structure subordinate and unchanged. The physical invention remains the integrated spin-caloritronic rectifying harvester; pipeline and HVAC deployments are examples of where that harvester can be used.

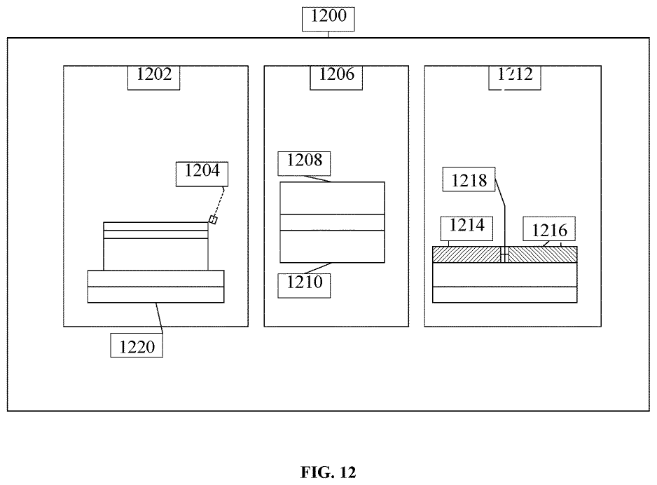

FIG. 12 is a schematic view of representative alternative configurations 1200. The alternative configurations 1200 can include a polymer-supported stack 1202, a low-temperature deposition route indicator 1204, a double-sided stack 1206, a first active face 1208, a second active face 1210, a mixed-heavy-metal stack 1212, a first heavy-metal region 1214, a second heavy-metal region 1216, a series-addition interconnect 1218, and an optional support substrate 1220. FIG. 12 is intended to preserve support for alternative and continuation-worthy implementations and should be treated as directed to alternative or prophetic embodiments unless a particular implementation has been reduced to practice or otherwise concretely validated.

The polymer-supported stack 1202 represents an alternative implementation in which the active harvesting structure is formed on a polymeric support rather than on a mica support. The low-temperature deposition route indicator 1204 is included to show that such an embodiment may employ a lower-temperature deposition sequence, an alternative growth route, or another modified process path suited to a polymer-compatible substrate. This configuration should be disclosed as an alternative embodiment and not as the preferred embodiment unless additional support is available.

The double-sided stack 1206 represents an alternative implementation in which active harvesting structures are provided on two opposing faces of a support substrate. The first active face 1208 and the second active face 1210 indicate that thermal gradients incident on either side, or gradients distributed across a double-sided architecture, may be harvested. Such a double-sided arrangement may be useful in some packaging or installation contexts, but it remains an alternative embodiment relative to the preferred single-stack laminate architecture described above.

The mixed-heavy-metal stack 1212 represents another alternative implementation in which a first heavy-metal region 1214 and a second heavy-metal region 1216 differ in heavy-metal composition, spin-Hall polarity, or related transduction characteristic. The series-addition interconnect 1218 may be used in some embodiments to combine or route outputs from the two heavy-metal regions. This architecture may be useful, for example, in embodiments using heavy metals with differing spin-Hall-angle sign or magnitude, but such embodiments should remain alternative or continuation-grade unless more direct support is added. The optional support substrate 1220 indicates that the alternative configurations may share a common structural support or may be built on distinct support structures.

The alternative configurations shown in FIG. 12 are important for preserving disclosure flexibility and for supporting later continuation practice, but they should not be allowed to obscure the identity of the presently disclosed core invention. The preferred and load-bearing invention remains the integrated ferrimagnetic spin-Seebeck layer, heavy-metal inverse-spin-Hall layer, chi-patterned conductive collection and impedance-transform structure, and zero-bias rectification architecture. FIG. 12 therefore serves as support for alternative embodiments, prophetic embodiments, and future claim targets while leaving the preferred architecture intact and dominant within the present specification.

The foregoing figures and associated embodiments demonstrate that the disclosed invention may be implemented across a range of deployment forms, packaging forms, material selections, and optional downstream electrical architectures while preserving a clear and defensible core mechanism. The invention is centered on the integrated conversion of a thermal gradient into a spin current, the conversion of that spin current into a charge signal, the collection and impedance transformation of that signal through a chi-patterned structure, and the rectification of that signal into DC output through zero-bias tunnel rectifiers. Preferred embodiments, optional embodiments, alternative embodiments, prophetic examples, downstream uses, and continuation-worthy targets should all be read in that order of subordination.

Unless expressly stated otherwise, dimensions, materials, ranges, operating conditions, and examples described herein are provided to illustrate the invention and to support one or more claim positions, and should not be read as limiting. Features described in connection with one embodiment may be combined with features of another embodiment unless incompatible.

Similarly, optional downstream accumulation, regulation, storage, or sensing modules may be included or omitted depending on the intended use case without departing from the core thermal-to-spin-to-charge rectifying architecture.

In preferred implementations, one or more design predicates or operating relations associated with the disclosed architecture may be machine-verified under a formalized model. Such machine verification may include, for example, verification of spin-current positivity, inverse-spin-Hall voltage positivity, impedance-cost non-negativity, matched-zero-cost conditions, rectified-power non-negativity, extraction quantization, or selected performance and flexibility predicates. These verified predicates provide a disclosed design-validation layer for preferred embodiments, but should not be understood as replacing empirical testing, physical prototyping, or the make-and-use disclosure set forth herein.

In a representative preferred formalization, the disclosed harvester is modeled in Lean 4 using structures corresponding to a spin-Seebeck layer, a spin-Hall layer, a chi-grid, a tunnel-diode array, a flexible substrate, a quantized extraction layer, and an integrated waste-heat harvester. In the source-reported formalization, machine-verified predicates include spinCurrent_pos, stating that J_s>0 for Delta T>0; isheVoltage_pos, stating that V_ISHE>0 for J_s>0; chi_offset_eq_phi_over_pi, stating that the preferred angular offset equals phi/pi in the formalized embodiment; impedance_pos, stating that Z_chi>0; matched_zero_cost, stating J(Z/Z)=0 at matched impedance; impedanceCost_nonneg, stating J(r)>=0 for r>0; rectifiedPower_nonneg, stating P_DC>=0; substrate_conformal, stating that the modeled substrate remains conformal above a stated bend-radius condition; extraction_pos; extraction_quantized; power_density_target; rectification_target; flexibility_target; and an integrated viability certificate for the modeled device. Additional source-reported theorem support is associated with chi-lattice geometry, first-order cancellation, coherence-exponent determination, and eight-tick phase balance. These formalized predicates are disclosed as a preferred design-validation layer for modeled implementations and should not be understood as replacing empirical characterization of physical hardware.

What is claimed is:

1. A waste-heat energy harvester comprising:
(a) a ferrimagnetic insulator layer configured to generate a spin current in response to a temperature gradient applied across the ferrimagnetic insulator layer;
(b) a heavy-metal layer disposed adjacent to the ferrimagnetic insulator layer and configured to convert the spin current into a charge voltage via an inverse spin Hall effect;
(c) a chi-patterned conductive structure formed from or integrated with the heavy-metal layer, the chi-patterned conductive structure being configured to collect the charge voltage and transform an effective source impedance associated with the heavy-metal layer; and
(d) one or more zero-bias tunnel rectifiers electrically coupled to the chi-patterned conductive structure and configured to rectify the collected charge voltage to produce DC electrical output.

2. The harvester of claim 1, wherein the chi-patterned conductive structure comprises counter-helical conductive paths arranged to define a plurality of distributed coupling nodes for the one or more zero-bias tunnel rectifiers.

3. The harvester of claim 1, wherein the counter-helical conductive paths define first and second interpenetrating mesh phases comprising repeated node locations and at least one peripheral bus region.

4. The harvester of claim 1, wherein the chi-patterned conductive structure is configured both:
(i) to transform the effective source impedance toward a rectifier load impedance; and
(ii) to suppress first-order perturbative field effects through counter-helical conductive-path structure.

5. The harvester of claim 1, wherein the chi-patterned conductive structure is dimensioned such that a load-to-source impedance ratio r=Z_load/Z_source is between 0.95 and 1.05, or such that a matching cost J(r)=0.5*(r+1/r)−1 is less than 0.001.

6. The harvester of claim 1, wherein the chi-patterned conductive structure is patterned from the heavy-metal layer such that inverse-spin-Hall transduction and chi-patterned collection/impedance transformation are provided by the same heavy-metal layer.

7. The harvester of claim 1, wherein the chi-patterned conductive structure has a period between about 3 micrometers and about 8 micrometers and a linewidth between about 100 nanometers and about 300 nanometers.

8. The harvester of claim 1, wherein the chi-patterned conductive structure has a pattern depth of about 45 nanometers including an overetch into an underlying spacer region to electrically isolate adjacent conductive traces.

9. The harvester of claim 1, wherein the ferrimagnetic insulator layer comprises a ferrimagnetic material selected from the group consisting of Co2Y hexaferrite, Co2Z hexaferrite, BaFe12O19, YIG, and Bi-substituted YIG, and wherein the heavy-metal layer comprises a metal selected from the group consisting of Pt, W, Ta, Ir, and Pd.

10. The harvester of claim 1, wherein the heavy-metal layer comprises Pt having a thickness of about 6 nanometers and the ferrimagnetic insulator layer comprises Co2Y hexaferrite having a thickness of about 5 micrometers.

11. The harvester of claim 1, wherein the one or more zero-bias tunnel rectifiers comprise metal-insulator-metal tunnel diodes including a Ti electrode, an Al2O3 tunnel barrier, and an Al electrode.

12. The harvester of claim 1, wherein the Ti electrode has a thickness of about 50 nanometers, the Al2O3 tunnel barrier has a thickness of about 1.8 nanometers, and the Al electrode has a thickness of about 50 nanometers.

13. The harvester of claim 1, wherein each tunnel diode has a junction area of about 100 nanometers by about 100 nanometers.

14. The harvester of claim 1, further comprising a flexible substrate supporting the ferrimagnetic insulator layer and the heavy-metal layer, an adhesive backing configured to mount the harvester on a curved thermal surface, and an encapsulation layer disposed over at least a portion of the harvester.

15. The harvester of claim 1, wherein the flexible substrate comprises muscovite mica and the encapsulation layer comprises parylene-C.

16. The harvester of claim 1, further comprising a power-conditioning circuit coupled to the DC electrical output and configured to provide a regulated output rail to a load.

17. The harvester of claim 1, wherein the power-conditioning circuit comprises a switched-capacitor accumulator and a release-control block configured to accumulate rectified energy prior to delivery to the load.

18. The harvester of claim 1, wherein the waste-heat energy harvester produces (i) a power density of at least 1.5 mW/cm\hat{ }2 when a temperature gradient of 90 K is applied across the ferrimagnetic insulator layer and (ii) a rectification efficiency of at least 35 percent.

19. A method of harvesting waste heat, comprising:
(a) applying a temperature gradient across a ferrimagnetic insulator layer to generate a spin current by a longitudinal spin-Seebeck effect; (b) transferring the spin current into an adjacent heavy-metal layer; (c) converting the spin current into a charge voltage in the heavy-metal layer through an inverse spin Hall effect; (d) collecting the charge voltage through a chi-patterned conductive structure formed from or integrated with the heavy-metal layer; (e) transforming an effective source impedance of the collected charge voltage toward a load condition presented by one or more zero-bias tunnel rectifiers; and (f) rectifying the collected charge voltage through the one or more zero-bias tunnel rectifiers to produce DC electrical output.

20. The method of claim 19, further comprising selecting or refining a geometry of the chi-patterned conductive structure according to a load-to-source impedance ratio r=Z_load/Z_source and a matching relation J(r)=0.5*(r+1/r)−1.
